(19) United States
(12) Patent Application Publication
(10) Pub. No.: US 2026/0278479 A1
(43) Pub. Date: Sep. 17, 2026

(54) SYSTEM AND METHOD FOR ENSEMBLE LEARNING

(71) Applicant: Nuvoton Technology Corporation, Hsinchu Science Park (TW)

(72) Inventor: Chih-Yen CHEN, Kaohsiung City (TW)

(21) Appl. No.: 19/328,544

(22) Filed: Sep. 15, 2025

(30) Foreign Application Priority Data
Mar. 17, 2025 (TW) 114109788

(51) Int. Cl. G06N 20/20; G06N 5/01

(52) U.S. Cl. CPC G06N 20/20; G06N 5/01

(57) ABSTRACT

A system for ensemble learning is provided. The system includes a plurality of slave computing devices and a master computing device. Each slave computing device is configured to use a weak classifier to obtain a classification result. The master computing device is configured to receive the classification results and output a final classification result based on the classification results.

### CROSS REFERENCE TO RELATED APPLICATIONS

This application claims priority of Taiwan patent application No. 114109788, filed Mar. 17, 2025, the entirety of which is incorporated by reference herein.

### TECHNICAL FIELD

The present disclosure relates to machine learning, and in particular it relates to an ensemble learning system and method.

### BACKGROUND

Edge computing is a distributed computing architecture in which data processing is performed on edge devices near the data source, rather than transmitting the data to a data center or a cloud computing platform. This helps to avoid delays in data transmission and enhances real-time processing capabilities. These characteristics are crucial in many applications, particularly those that require real-time decision-making, such as autonomous vehicles, smart cities, and industrial automation.

Common sources of data in edge computing include sensors, Internet of Things (IoT) devices, smart devices, and the like. The amount of data generated by these devices is typically substantial. However, due to the limited computational and storage resources of edge devices, it is often difficult to perform computations with higher complexity (such as more complex machine learning model inference) or process larger volumes of data (such as machine learning model training).

Generally speaking, computations and processing tasks that are difficult to perform on edge devices are completed at data centers or cloud computing platforms. Afterward, the edge device continues its operations based on the computation or processing results returned by the data center or cloud computing platform. For example, after training a simple model at a cloud computing platform, the trained simple model is then deployed to an edge device. Similarly, after performing inference of a complex model at the cloud computing platform, the inference results are transmitted to the edge device. However, the above approach can no longer meet the demands of today's complex and performance-critical application scenarios, such as speech recognition, image classification, and autonomous driving.

Therefore, an ensemble learning system and method is needed to address the above issues.

### BRIEF SUMMARY

An embodiment of the present disclosure provides an ensemble learning system, including slave computing devices and a master computing device. Each slave computing device is configured to use a weak classifier to obtain a classification result. The master computing device is configured to receive classification results from the slave computing devices and output a final classification result based on the received classification results.

In one embodiment, each slave computing device is configured to receive first sensor data from a sensor during the training phase, and to use the first sensor data to train a weak classifier. During the inference phase, each slave computing device is configured to receive second sensor data from the sensor, and to use the weak classifier to obtain a classification result for the second sensor data. The master computing device is configured to receive the classification result from the slave computing device during the inference phase. The master computing device is configured to output a final classification result and based on the classification result.

In one embodiment, each slave computing device is further configured to, during the training phase, share a portion of the first sensor data with other slave computing devices, and receive shared portions from other slave computing devices; and use the first sensor data and the shared portions to train a weak classifier. The data format of the first sensor data from each slave computing device is the same.

In one embodiment, the master computing device is further configured to, during the inference phase, take the mode of the classification results as the final classification result.

In one embodiment, the weak classifier of each slave computing device is a decision tree model.

An embodiment of the present disclosure provides an ensemble learning method executed on a computer system. The computer system includes a plurality of computation devices and a master computing device. The ensemble learning method includes using a weak classifier to obtain classification results through each slave computing device; and, through the master computing device, receiving the classification results from the slave computing devices and outputting the final classification result based on the classification results.

An embodiment of the present disclosure provides an ensemble learning system, which includes a plurality of slave computing devices. Each slave computing device is configured to share the weak classifier with other slave computing devices and receive weak classifiers from other slave computing devices. Each slave computing device is further configured to use the weak classifier and the other weak classifiers to obtain the final classification result.

In one embodiment, each slave computing device is further configured to, during the training phase, receive first sensor data from a sensor; use the first sensor data to train a weak classifier; and share the weak classifier with other slave computing devices, and receive other weak classifiers from other slave computing devices. Each slave computing device is further configured to, during the inference phase, receive second sensor data from a sensor; and use the weak classifier and the other weak classifiers to classify the second sensor data in order to obtain the final classification result. The data format of the first sensor data from each slave computing device is the same.

In one embodiment, each slave computing device is further configured to, during the inference phase, input second sensor data into the weak classifier and other weak classifiers to obtain individual classification results. Each slave computing device is further configured to output the final classification result based on the classification results.

In one embodiment, each slave computing device is further configured to, during the inference phase, take the mode of the classification results as the final classification result.

In one embodiment, each slave computing device is further configured to, during the training phase, share a portion of the first sensor data with other slave computing devices, and receive shared portions from other slave computing devices; and use the first sensor data and the shared portions to train the weak classifier.

In one embodiment, the weak classifier of each slave computing device is a decision tree model.

In one embodiment, the ensemble learning system further includes a main computing device. The main computing device is configured to, during the inference phase, evaluate whether the performance of the weak classifier of each slave computing device exceeds a specified threshold; and, in response to the performance of the weak classifier not exceeding the specified threshold, prevent the slave computing device from sharing the weak classifier with other slave computing devices.

An embodiment of the present disclosure provides an ensemble learning method executed on a computer system, wherein the computer system includes a plurality of slave computing devices. The ensemble learning method includes using each slave computing device share the weak classifier with other slave computing devices, and receive other weak classifiers from other slave computing devices. The ensemble learning method further includes using the weak classifier and other weak classifiers through each slave computing device to classify the second sensor data, in order to obtain the final classification data.

The ensemble learning system and method provided herein can be implemented for ensemble learning training and inference on an edge computing system. Furthermore, by training weak classifiers on individual edge devices and deploying the strong classifier, which is formed by integrating these weak classifiers, across the entire edge computing system or individual edge devices, the accuracy of inference at the edge can be improved. On the other hand, this approach also reduces the latency caused by data transmission to the cloud, thus shortening the model training time and enhancing real-time inference capabilities.

### BRIEF DESCRIPTION OF THE DRAWINGS

The present disclosure can be better understood from the following description of exemplary embodiments in conjunction with the accompanying drawings. Furthermore, it should be understood that in the flowcharts of the present disclosure, the execution order of the blocks may be changed, and/or certain blocks may be modified, omitted, or combined.

FIG. 1 shows a system architecture diagram of an ensemble learning system according to an embodiment of the present invention;

FIG. 2A shows a data flow diagram of the training phase of the ensemble learning method according to an embodiment of the present invention;

FIG. 2B shows data flow diagram of the inference phase of the ensemble learning method according to an embodiment of the present invention;

FIG. 3 shows a system architecture diagram of the ensemble learning system according to an embodiment of the present invention;

FIG. 4A shows a data flow diagram of the training phase of the ensemble learning method according to an embodiment of the present invention;

FIG. 4B shows a schematic diagram of a slave computing device completing the training phase in this embodiment;

FIG. 4C shows a data flow diagram of the inference phase of the ensemble learning method according to an embodiment of the present invention; and

FIG. 5 shows a schematic diagram of the steps S422 performed by a slave computing device in the embodiment that implements the inference phase shown in FIG. 4C.

### DETAILED DESCRIPTION

The following description is made for the purpose of illustrating the general principles of the disclosure and should not be taken in a limiting sense. The scope of the disclosure is best determined by reference to the appended claims.

In the embodiments listed below, the same reference numerals will represent the same or similar components or elements.

In this specification and the claims of the patent application, designations such as ‘first’, ‘second’, and so on are for convenience of description only, and there is no inherent order or precedence implied between them.

The description of embodiments of devices or systems in this specification also applies to embodiments of methods, and vice versa.

The embodiment of the present disclosure provides an ensemble learning system. This ensemble learning system comprises a plurality of slave computing devices and a master computing device. Each slave computing device is configured to use a weak classifier to obtain a classification result, and the master computing device is configured to receive classification results from the slave computing devices and output a final classification result based on the classification results.

The master computing device and slave computing devices can be any processing device with computational capabilities located at the edge of the network (also known as edge devices), such as microcontrollers, personal computers (e.g., desktop computers or laptops), server computers, mobile devices (e.g., tablets or smartphones), wearable devices (e.g., smartwatches), network devices (e.g., routers), or in-vehicle information systems of autonomous vehicles. However, the present disclosure is not limited to these examples.

It should be noted that the present disclosure does not limit the communication methods between the master computing device and the slave computing devices. Communication can occur through wired connections, either directly or indirectly, such as through Inter-Integrated Circuit (I2C), Ethernet, etc. It can also occur through wireless connections, either directly or indirectly, such as Bluetooth, Wi-Fi, etc. However, the present disclosure is not limited to these examples.

Generally speaking, a weak classifier refers to a classification model that is smaller in scale but may have lower classification accuracy. Due to its lower computational complexity and faster training speed, a weak classifier is more suitable for edge devices with limited computational resources compared to other classification models. In one embodiment, the weak classifier may be a decision tree model, such as a decision stump or a decision tree with fewer layers. In another embodiment, the weak classifier may be a linear classifier, such as a perceptron.

It should be noted that the present disclosure does not limit the weak classifier to the smaller-scale classification models mentioned above. In cases where the computational resources of the slave computing device permit, the weak classifier may be a classification model implemented using methods such as k-Nearest Neighbors (k-NN), Support Vector Machines (SVM), Neural Networks (NN), etc. However, the present disclosure is not limited to these examples.

It should be noted that the present disclosure does not limit the classification algorithms individually adopted by the weak classifiers. In other words, in various embodiments of the present disclosure, the classification algorithms used by the weak classifiers can all be the same, partially the same, or completely different. In one embodiment, the classification algorithm adopted by the weak classifier may be determined based on the computational capabilities of the slave computing device. For example, the weak classifier of a device with lower computational capacity may be a decision stump, while the weak classifier of a device with higher computational capacity may be a decision tree with more layers.

The training method of the weak classifier depends on the classification algorithm it adopts. In one embodiment, the classification algorithm used by the weak classifier is a supervised machine learning algorithm (e.g., decision trees, support vector machines, etc.), which can be trained using labeled first sensor data. In another embodiment, the classification algorithm used by the weak classifier is an unsupervised machine learning algorithm (e.g., Isolation Forest, etc.), which can be trained using unlabeled first sensor data.

The classification result can each be a class label or a probability vector that includes the probability of each class, but the present disclosure is not limited to this. For example, in anomaly classification, the classification result can be a single value, such as 0 or 1, where 0 represents normal and 1 represents anomaly. Alternatively, the classification result can be a probability vector of size 1×2, such as [0.8, 0.2], which can represent a 0.8 probability of being normal and a 0.2 probability of being anomalous.

The presentation format of the final classification result depends on the classification result. For example, in the case where the classification result is a class label, the final classification result will also be presented in the form of a class label. In the case where the classification result is a class probability, the final classification result may be presented in the form of class probabilities, or further converted into the form of a class label. However, the present disclosure is not limited to this.

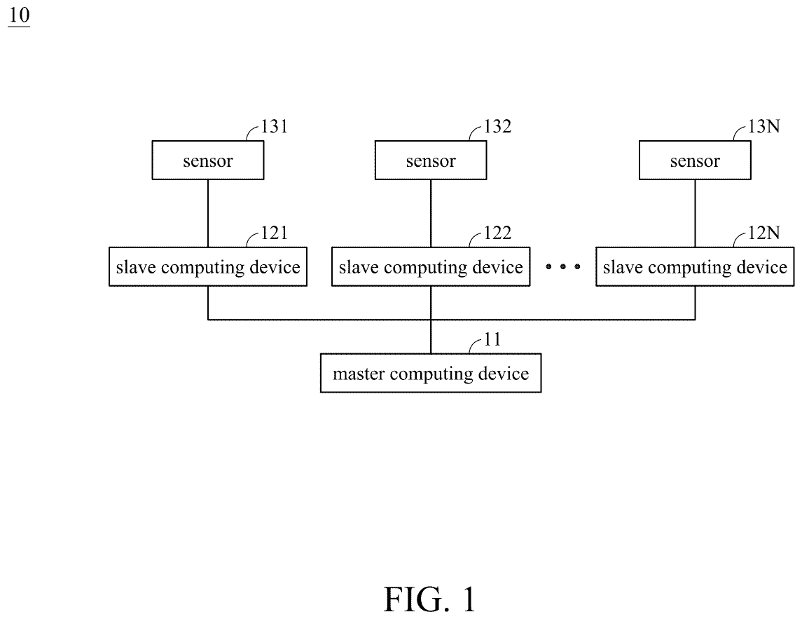

FIG. 1 shows a system architecture diagram of an ensemble learning system 10 according to one embodiment of the present invention. As shown in FIG. 1, the ensemble learning system 10 comprises a master computing device 11, slave computing devices 121, 122, . . . , 12N, and sensors 131, 132, . . . , 13N. The slave computing devices 121, 122, . . . , 12N are communicatively connected to the master computing device 11 and the respective corresponding sensors 131, 132, . . . , 13N.

The master computing device 11 and slave computing devices 121, 122, ..., 12N can be any processing device with computational capabilities located at the edge of the network (also known as edge devices), such as microcontrollers, personal computers (e.g., desktop computers or laptops), server computers, mobile devices (e.g., tablets or smartphones), wearable devices (e.g., smartwatches), network devices (e.g., routers), or autonomous vehicles. However, the present disclosure is not limited to these examples.

Sensors 131, 132, . . . , 13N can be any devices used to detect events or changes in the environment and transmit the information to other electronic devices, such as temperature and humidity sensors, acceleration sensors, ultrasonic sensors, sound sensors, image sensors, etc. However, the present disclosure is not limited to these examples. It should be noted that the present disclosure does not limit the individual types of sensors 131, 132, . . . , 13N. In other words, in the embodiments of the present disclosure, the types of sensors 131, 132, . . . , 13N may all be the same, partially the same, or completely different.

It should be noted that the present disclosure does not limit the communication methods between the master computing device 11, slave computing devices 121, 122, . . . , 12N, and sensors 131, 132, . . . , 13N. Communication can occur through wired connections, either directly or indirectly, such as through Inter-Integrated Circuit (I2C), Ethernet, etc. It can also occur through wireless connections, either directly or indirectly, such as Bluetooth, Wi-Fi, etc. However, the present disclosure is not limited to these examples.

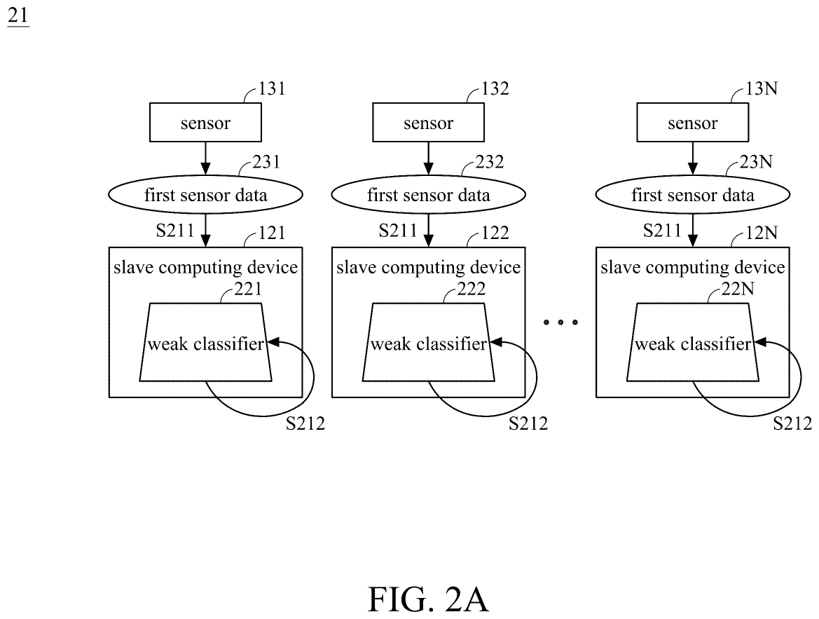

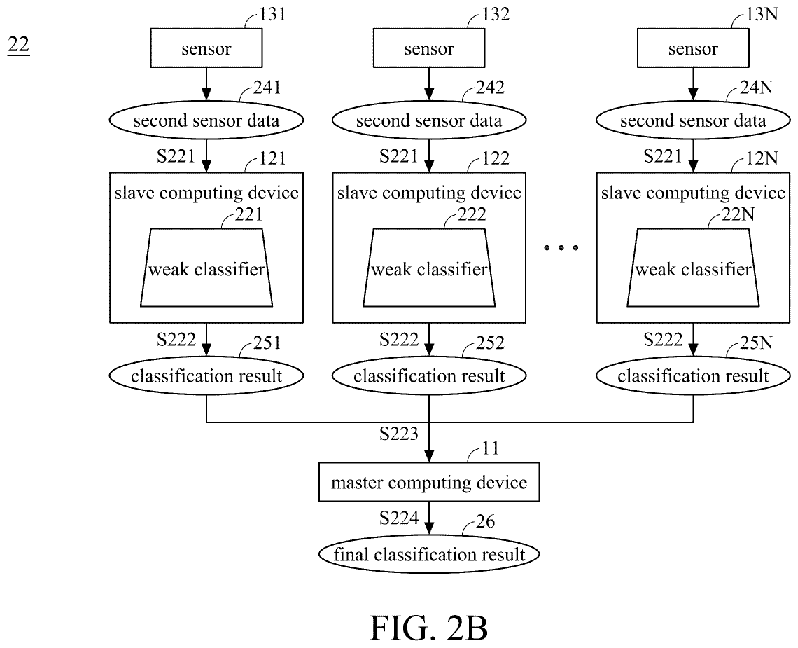

FIG. 2A is a data flow diagram of the training phase 21 of the ensemble learning method according to an embodiment of the present invention. The ensemble learning system 10 performs this ensemble learning method, with the slave computing devices 121, 122, . . . , 12N executing the training phase 21. As shown in FIG. 2A, the training phase 21 includes steps S211 and S212. The following describes steps S211 and S212.

In step S211, the slave computing devices 121, 122, . . . , 12N receive first sensor data 231, 232, . . . , 23N respectively from their corresponding sensors 131, 132, . . . , 13N.

The first sensor data 231, 232, . . . , 23N correspond to the types of sensors 131, 132, . . . , 13N, and can include temperature and humidity values, light intensity values, acceleration values, vibration frequency values, sound intensity values, or coordinate values, etc. However, the present disclosure is not limited to these examples.

In step S212, the slave computing devices 121, 122, . . . , 12N use their respective first sensor data 231, 232, . . . , 23N to train their respective weak classifiers 221, 222, . . . , 22N.

In one embodiment, the weak classifiers 221, 222, . . . , 22N may be decision tree models, such as decision stumps or decision trees with fewer layers. In another embodiment, the weak classifiers 221, 222, . . . , 22N may be linear classifiers, such as perceptrons, etc.

It should be noted that the present disclosure does not limit the weak classifiers 221, 222, . . . , 22N to the small-scale classification models mentioned above. In cases where the computational resources of the slave computing devices 121, 122, . . . , 12N permit, the weak classifiers 221, 222, . . . , 22N may be classification models implemented using methods such as k-Nearest Neighbors (k-NN), Support Vector Machines (SVM), Neural Networks (NN), etc. However, the present disclosure is not limited to these examples.

It should be noted that the present disclosure does not limit the classification algorithms adopted by the individual weak classifiers 221, 222, . . . , 22N. In other words, in the embodiments of the present disclosure, the classification algorithms adopted by the weak classifiers 221, 222, . . . , 22N may all be the same, partially the same, or completely different. In one embodiment, the classification algorithm adopted by the weak classifiers 221, 222, . . . , 22N may be determined based on the computational capability of the slave computing devices 121, 122, . . . , 12N. For example, the weak classifier of a slave computing device 121, 122, . . . , 12N with lower computational capability may be a decision stump, while the weak classifier of a slave computing device 121, 122, . . . , 12N with higher computational capability may be a decision tree with more layers.

The training method of the weak classifiers 221, 222, . . . , 22N depends on the classification algorithm they adopt. In one embodiment, the classification algorithm adopted by the weak classifiers is a supervised machine learning algorithm (e.g., decision trees, support vector machines, etc.), which can be trained using labeled first sensor data. In another embodiment, the classification algorithm adopted by the weak classifiers is an unsupervised machine learning algorithm (e.g., Isolation Forest, etc.), which can be trained using unlabeled first sensor data.

In one embodiment, the data format of the first sensor data 231, 232, . . . , 23N is the same. For example, the first sensor data 231, 232, . . . , 23N may have the same data fields, such as temperature values. In this embodiment, the slave computing devices 121, 122, . . . , 12N can communicate with each other. Furthermore, each slave computing device 121, 122, . . . , 12N shares a portion of its respective first sensor data 231, 232, . . . , 23N with other slave computing devices and receives shared portions from other slave computing devices. Each slave computing device then uses its respective first sensor data and the shared portions to train its corresponding weak classifiers 221, 222, . . . , 22N.

It should be noted that the present disclosure does not limit the communication methods between the slave computing devices 121, 122, . . . , 12N. Communication can occur through wired connections, either directly or indirectly, such as through Inter-Integrated Circuit (I2C), Ethernet, etc. It can also occur through wireless connections, either directly or indirectly, such as Bluetooth, Wi-Fi, etc. However, the present disclosure is not limited to these examples.

It should be noted that the present disclosure does not limit the proportion of the first sensor data that is shared. In one embodiment, the slave computing devices may share a fixed proportion (e.g., 20%) of the first sensor data with other slave computing devices. In another embodiment, the proportion of the shared data may be determined based on the computational capability of other slave computing devices. For example, for a slave computing device with higher computational capability, 90% of the first sensor data may be shared with it, while for a slave computing device with lower computational capability, only 5% of the first sensor data may be shared. However, the present disclosure is not limited to these examples.

It is worth noting that by sharing the first sensor data with other slave computing devices, the amount of training data for the weak classifiers can be increased, without being limited by the data collection capability of a single sensor. This will help improve the generalization ability and classification accuracy of the weak classifiers.

FIG. 2B is a data flow diagram of the inference phase 22 of the ensemble learning method according to an embodiment of the present invention. The inference phase 22 is executed in the ensemble learning system 10. As shown in FIG. 2B, the inference phase 22 includes steps S221 to S224. The following describes steps S221 to S224.

In step S221, the slave computing devices 121, 122, . . . , 12N respectively receive the second sensor data 241, 242, . . . , 24N from their corresponding sensors 131, 132, . . . , 13N.

The second sensor data 241, 242, . . . , 24N similarly corresponds to the types of sensors 131, 132, . . . , 13N. For example, it could be temperature and humidity values, light intensity values, acceleration values, vibration frequency values, sound intensity values, and coordinate values, but the present disclosure is not limited to these examples.

In step S222, the slave computing devices 121, 122, . . . , 12N use their respective weak classifiers 221, 222, . . . , 22N to obtain the classification results 251, 252, . . . , 25N of their respective second sensor data 241, 242, . . . , 24N.

The classification results 251, 252, . . . , 25N may each be a class label, or a probability vector containing the probability of each class, but the present disclosure is not limited to these examples. For anomaly classification, the classification results 251, 252, . . . , 25N may be a single value such as 0 or 1, where 0 may represent normal and 1 may represent anomaly. Alternatively, the classification results 251, 252, . . . , 25N may be a probability vector of size 1×2, such as [0.8, 0.2], where 0.8 represents the probability of being normal and 0.2 represents the probability of being anomalous.

In step S223, the master computing device 11 receives the classification results 251, 252, . . . , 25N from the slave computing devices 121, 122, . . . , 12N. In step S224, the master computing device 11 outputs the final classification result 26 based on the classification results 251, 252, . . . , 25N.

In one embodiment, the master computing device 11 takes the mode of the classification results 251, 252, . . . , 25N as the final classification result 26. In another embodiment, the master computing device 11 performs a weighted average of the classification results 251, 252, . . . , 25N to obtain the final classification result 26. In other embodiments, the master computing device 11 takes the maximum value of the classification results 251, 252, . . . , 25N as the final classification result 26, but the present disclosure is not limited to this.

The presentation format of the final classification result 26 depends on the format of the classification results 251, 252, . . . , 25N. For example, if the classification results 251, 252, . . . , 25N are class labels, the final classification result 26 will also be presented in the form of a class label. If the classification results 251, 252, . . . , 25N are class probabilities, the final classification result 26 may be presented in the form of class probabilities, or it may be further converted into a class label format. However, the present disclosure is not limited to this.

It should be noted that in the above implementation examples, even though the types of sensors 131, 132, . . . , 13N are different, the weak classifiers 221, 222, . . . , 22N should have a consistent classification goal, such as determining normal/anomalous. For example, in a building access control system, the weak classifiers 221, 222, . . . , 22N in the computing devices 121, 122, . . . , 12N can judge whether the building is being intruded upon by using the sensor data from cameras, vibration sensors, infrared sensors, etc. Then, the main computing device 11 integrates the results of these judgments to obtain the final decision. By considering the results from different weak classifiers from multiple perspectives, the system can effectively avoid misjudgments by a single weak classifier, thereby improving the overall accuracy of the system's decision-making.

Through the combination of the computing devices 121, 122, . . . , 12N and the main computing device 11, the ensemble learning system 10 forms a strong classifier at the functional level.

It is worth noting that strong classifiers (such as random forests) typically have higher model complexity, making them more difficult to deploy on edge devices with limited computational resources. However, the ensemble learning system 10 effectively utilizes the computational resources of multiple edge devices by distributing the weak classifiers (such as the decision trees in a random forest) across different edge devices, thereby enabling the realization of a strong classifier, such as a random forest model.

The embodiment of the present disclosure provides another variant of the ensemble learning system. This ensemble learning system includes a plurality of computing devices, each configured to share a weak classifier with other computing devices and receive other weak classifiers from those devices. It then uses the weak classifiers along with the other weak classifiers to obtain a final classification result.

The computing devices, as described above, can be any type of processing device with computational capabilities that is located at the edge of the network (also known as edge devices). The communication between the computing devices can occur either through wired or wireless methods, either directly or indirectly.

In addition, the classification algorithms adopted by each weak classifier can depend on the computational resources of the computing devices. They can all be the same, partially the same, or entirely different. The training method of the weak classifiers will also depend on whether the adopted classification algorithm is a supervised machine learning algorithm or an unsupervised machine learning algorithm.

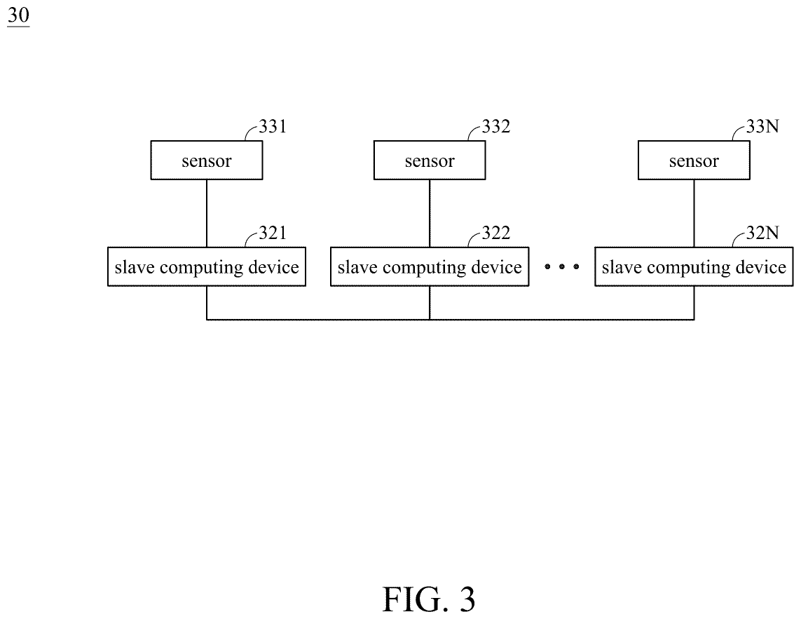

FIG. 3 is a system architecture diagram of an ensemble learning system 30 according to one embodiment of the present invention. As shown in FIG. 3, the ensemble learning system 30 includes slave computing devices 321, 322, . . . , 32N and sensors 331, 332 . . . 33N. The slave computing devices 321, . . . , 32N can communicate with each other, and can also communicate with their respective corresponding sensors 331, . . . , 33N.

The slave computing devices 321, . . . , 32N can be any processing device with computational capabilities located at the edge of the network (also known as edge devices), such as microcontrollers, personal computers (e.g., desktop computers or laptops), server computers, mobile devices (e.g., tablets or smartphones), wearable devices (e.g., smartwatches), network devices (e.g., routers), or autonomous vehicle systems, but the disclosure is not limited to these.

The types of sensors 331, . . . , 33N must be consistent, and they can all be one of the following, for example: temperature and humidity sensors, acceleration sensors, ultrasonic sensors, sound sensors, or image sensors. However, the disclosure is not limited to these specific sensor types.

It should be noted that the present disclosure does not limit the communication methods between the slave computing devices 321, . . . , 32N and between each computing device and its corresponding sensor 331, . . . , 33N. Communication can be performed in a wired manner, either directly or indirectly, such as through Inter-Integrated Circuit (I2C), Ethernet, etc., or in a wireless manner, either directly or indirectly, such as via Bluetooth, Wi-Fi, etc. However, the disclosure is not limited to these communication methods.

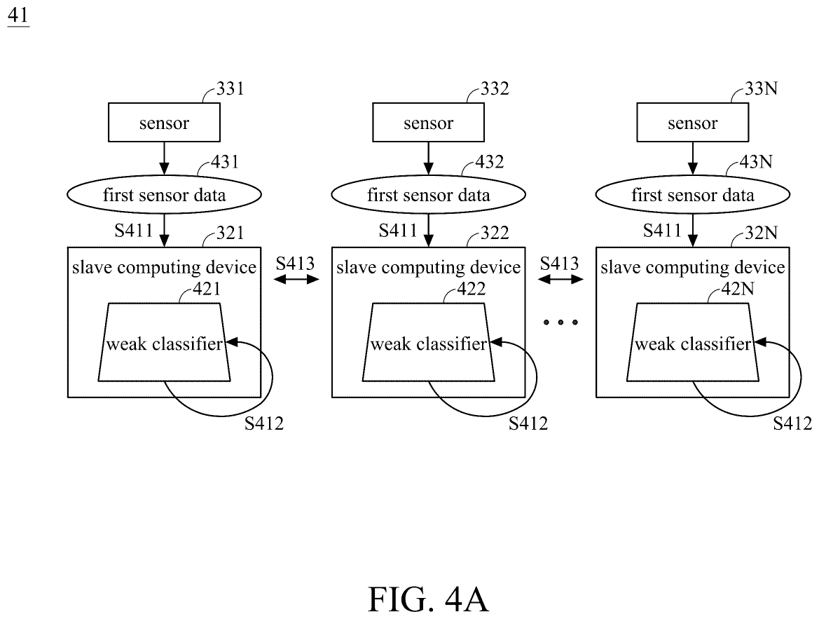

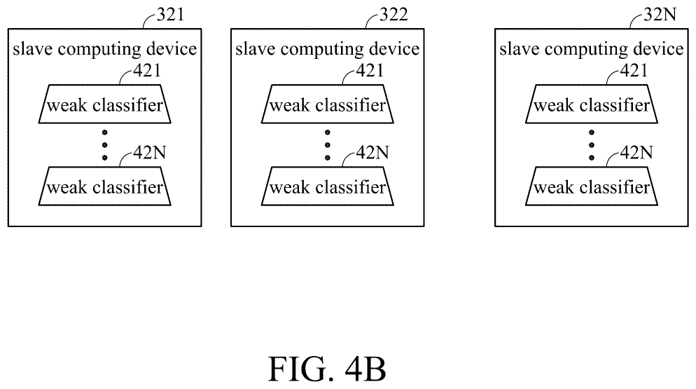

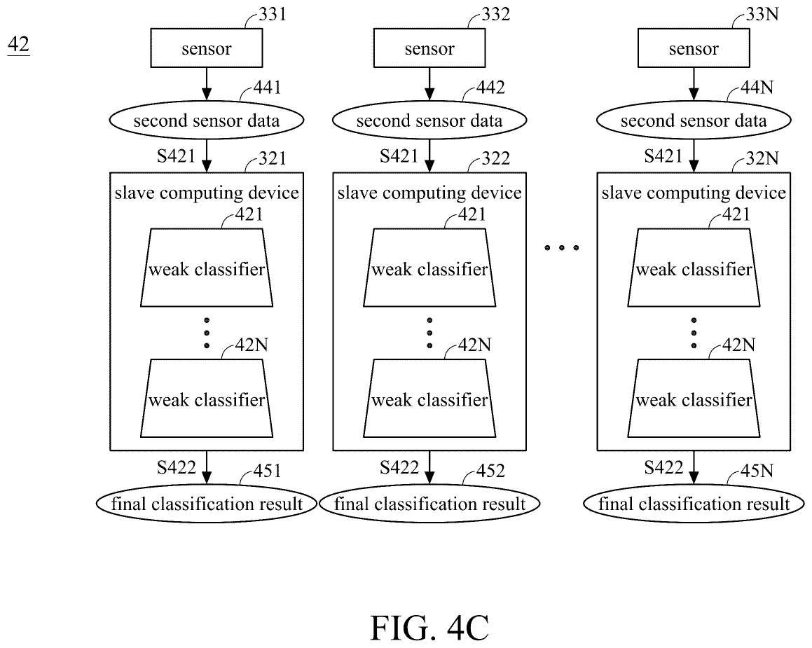

FIG. 4A is a data flow diagram of the training phase 41 of an ensemble learning method 40 according to one embodiment of the present invention. The training phase 41 is executed in the ensemble learning system 30. As shown in FIG. 4A, the training phase 41 includes steps S411 to S413.

Accordingly, FIG. 4B is a schematic diagram of the slave computing devices 321 . . . 32N after completing the training phase in this embodiment. The following will describe steps S411 to S413 with reference to both FIG. 4A and FIG. 4B.

In step S411, the slave computing devices 321, . . . , 32N receive the first sensor data 431, . . . , 43N from their corresponding sensors 331, . . . , 33N.

The type of the first sensor data 431, . . . , 43N will depend on the type of the sensors 331, ..., 33N, and it can include temperature and humidity values, light intensity values, acceleration values, vibration frequency values, sound intensity values, coordinate values, etc. However, the disclosure is not limited to these. The data format of the first sensor data 431, . . . , 43N must be consistent. For example, the first sensor data 431, . . . , 43N must have the same data fields, such as temperature values.

In step S412, the slave computing devices 321, . . . , 32N use their respective first sensor data 431, . . . , 43N to train their respective weak classifiers 421, . . . , 42N.

In cases where the computing resources of the slave computing devices 321, . . . , 32N are limited, the weak classifiers 421, . . . , 42N can be decision tree models, such as decision stump or decision trees with fewer layers, or linear classifiers like perceptrons. In cases where the computing resources of the slave computing devices 321, . . . , 32N allow for more complex models, the weak classifiers 421, . . . , 42N can be classification models implemented using k-nearest neighbors (k-NN), support vector machines (SVM), neural networks, etc. However, the disclosure is not limited to these options.

It should be noted that the disclosure does not limit the classification algorithms adopted by each weak classifier 421, .. . . , 42N. In other words, the classification algorithms used by the weak classifiers 421, . . . , 42N can all be the same, partially the same, or entirely different. However, the disclosure is not limited to this. In one embodiment, the classification algorithm chosen by the weak classifiers 421, . . . , 42N may be determined based on the computing capability of the respective slave computing devices 321, . . . , 32N. For example, a weak classifier in each slave computing device 321, . . . , 32N with lower computational power may be a decision stump, while a weak classifier in each slave computing device 321, . . . , 32N with better computational power may be a decision tree with more layers.

The training method of the weak classifiers 421, . . . , 42N depends on the classification algorithm they use. In one embodiment, the classification algorithm adopted by the weak classifiers is a supervised machine learning algorithm (e.g., decision trees, support vector machines, etc.), which can use labeled first sensor data for training. In another embodiment, the classification algorithm adopted by the weak classifiers is an unsupervised machine learning algorithm (e.g., Isolation Forest, etc.), which can use unlabeled first sensor data for training.

In one embodiment, each of the slave computing devices 321, . . . , 32N further shares a portion of its individual first sensor data 431, . . . , 43N with other computing devices, and receives portions shared by other computing devices, and uses its own first sensor data and the shared portions to train its respective weak classifiers 421, . . . , 42N.

It should be noted that the disclosure does not limit the proportion of the first sensor data that is shared. In one embodiment, a computing device can share a fixed proportion (e.g., 20%) of its first sensor data with other computing devices. In another embodiment, the proportion of the shared portion can be determined based on the computational capability of the other computing devices. For example, for computing devices with better computational capabilities, 90% of the first sensor data can be shared with them, while for computing devices with lower computational capabilities, only 5% of the first sensor data can be shared. However, this disclosure is not limited to these examples.

It is worth noting that by sharing the first sensor data with other computing devices, the amount of training data for the weak classifiers can be increased, without being limited by the data collection capability of a single sensor. This will help improve the generalization ability and classification accuracy of the weak classifiers.

In step S413, each of the slave computing devices 321, . . . , 32N further shares its respective weak classifiers 421, . . . , 42N with other computing devices, and receives weak classifiers from other computing devices. Afterwards, as shown in FIG. 4B, each computing device will include the trained weak classifiers 421, . . . , 42N.

In one embodiment, the ensemble learning system 30 further includes a main computing device. In one embodiment, the main computing device evaluates during the training phase 41 whether the performance of the weak classifiers 421, . . . , 42N exceeds a specified threshold. The performance of weak classifiers 421, . . . , 42N can be assessed using common model performance metrics such as accuracy or precision, but this disclosure is not limited to these. In addition, the main computing device, during the training phase 41, will respond by preventing a weak classifier from being shared from one computing device to another if its performance does not exceed the specified threshold. In one embodiment, the main computing device, during the training phase 41, will also decide whether to allow the receiving of other classifiers from other computing devices, based on the current computational resources of the receiving device. For example, if the memory size of the receiving device is only a few tens of KB, it will not be allowed to receive other classifiers from other computing devices.

It is noteworthy that by controlling the transmission or reception of classifiers through the main computing device, the number of weak classifiers included in the slave computing device can be dynamically controlled. In other words, the main computing device can be used to control the size of the strong classifier in the slave computing device, thereby achieving optimal utilization of computational resources.

FIG. 4C is a data flow diagram of the inference phase 42 of the ensemble learning method according to one embodiment of the present invention, which is executed in the ensemble learning system 30. As shown in FIG. 4C, the inference phase 42 includes steps S421 and S422. The following describes steps S421 and S422.

In step S421, the slave computing devices 321, . . . , 332N respectively receive the second sensor data 441, . . . , 44N from their corresponding sensors 331, . . . , 33N.

The second sensor data 441, . . . , 44N correspond to the types of sensors 331, . . . , 33N, which can include temperature and humidity values, light intensity values, acceleration values, vibration frequency values, sound intensity values, coordinate values, and so on. However, this disclosure is not limited to these.

In step S422, the slave computing devices 321, . . . , 32N use weak classifiers 421 . . . , 42N to classify their respective second sensor data 441, . . . , 44N to obtain their respective final classification results 451, . . . , 45N. For example, slave computing device 321 uses weak classifier 421 and other weak classifiers 422, . . . , 42N, which form a strong classifier, to classify the second sensor data 441 and obtain the final classification result 451.

The final classification results 451, . . . , 45N can be class labels or probability vectors that include the probabilities for each class, but this disclosure is not limited to these. Taking anomaly classification as an example, the classification results 451, . . . , 45N can be a single value such as 0 or 1, where 0 represents normal and 1 represents anomaly. Alternatively, the classification results 451, . . . , 45N can be a probability vector of size 1×2, such as [0.8, 0.2], which means there is an 80% probability of being normal and a 20% probability of being anomalous.

It should be noted that although in FIG. 4C, the slave computing devices 321, . . . 32N all perform steps S421 and S422, this disclosure does not limit the slave computing devices 321, . . . , 32N to performing steps S421 and S422 together. In other words, during the inference phase, the slave computing devices 321, . . . , 32N can independently execute steps S421 and S422.

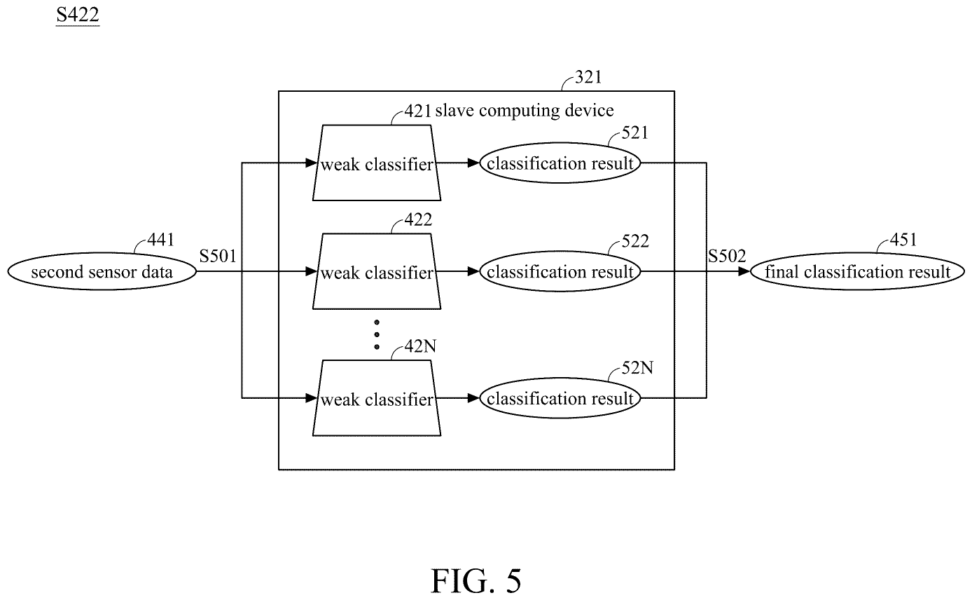

FIG. 5 is a schematic diagram illustrating step S422 executed by the slave computing device 321 according to an embodiment of the present invention, based on the implementation shown in FIG. 4C. As shown in FIG. 5, step S422 includes steps S501 and S502. The following describes steps S501 and S502.

In step S501, the slave computing device 321 inputs the second sensor data 441 to weak classifiers 421, . . . , 42N to obtain individual classification results 521, . . . , 52N. In step S502, the slave computing device 321 outputs the final classification result 451 based on the classification results 521, . . . , 52N.

In one embodiment, the slave computing device 321 takes the mode of the classification results 521, . . . , 52N as the final classification result 451. In another embodiment, the slave computing device 321 computes the weighted average of the classification results 521, . . . , 52N to obtain the final classification result 451. In other embodiments, the slave computing device 321 takes the maximum value of the classification results 521, . . . , 52N as the final classification result 451. However, this disclosure is not limited to these.

The classification results 521, . . . , 52N can be class labels or the probabilities for each class, but this disclosure is not limited to these. In the aforementioned embodiments, the format of the classification results 521, . . . , 52N will affect the final classification result 451. For example, in the case where the classification results 521, . . . , 52N are class labels, the final classification result 451 will also be presented in the form of a class label. In the case where the classification results 521, . . . , 52N are class probabilities, the final classification result 451 will also be presented in the form of class probabilities, or it may be further converted to be presented as a class label. However, this disclosure is not limited to these.

It is noteworthy that, for each slave computing device, considering the classification results of different weak classifiers from multiple perspectives can effectively avoid the issue of a single weak classifier's misclassification, thereby improving the classification accuracy of the slave computing device.

Furthermore, by sharing weak classifiers, a strong classifier can be formed within the slave computing device 321. In the embodiment where weak classifiers 421, . . . , 42N are decision tree models, the weak classifiers 421, . . . , 42N form a random forest model within the slave computing device 321.

It is noteworthy that the model complexity of a strong classifier (such as a random forest) is typically high, making it difficult to train on edge devices with limited computational resources. However, the ensemble learning system 30 can effectively utilize the computational resources of multiple edge devices to train a strong classifier (such as a random forest) by distributing weak classifiers (such as decision trees in a random forest) across different edge devices. Afterward, the trained strong classifier can be deployed on a single edge device.

The ensemble learning system and method provided in this disclosure can be implemented for training and inference of ensemble learning on an Edge Computing System. Furthermore, by training weak classifiers on individual edge devices and deploying the strong classifier, which is formed by integrating these weak classifiers, either across the entire edge computing system or on individual edge devices, it can, on one hand, improve the accuracy of edge-side inference, and on the other hand, reduce the latency caused by data transmission to the cloud. This, in turn, shortens model training time and enhances the ability for real-time inference.

The above paragraphs describe various embodiments. Clearly, the teachings of this disclosure can be implemented in multiple ways, and any specific architecture or functionality disclosed in the examples is merely representative. According to the teachings of this disclosure, those skilled in the art should understand that each embodiment disclosed herein can be independently implemented or combined in two or more embodiments.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An ensemble learning system, comprising:
a plurality of slave computing devices, wherein each slave computing device is configured to use a weak classifier to obtain a classification result; and
a master computing device, configured to:
receive the classification results from the slave computing devices; and
output a final classification result based on the classification results.

2. The ensemble learning system as claimed in claim 1, wherein each slave computing device is further configured to:
during a training phase, receive first sensor data from a sensor and use the first sensor data to train the weak classifier; and
during an inference phase, receive second sensor data from the sensor and use the weak classifier to obtain the classification result for the second sensor data,
wherein during the inference phase, the master computing device is configured to:
receive the classification results from the slave computing devices; and
output the final classification result based on the classification results.

3. The ensemble learning system as claimed in claim 2, wherein the master computing device is configured to:
during the inference phase, take a mode of the classification results as the final classification result.

4. The ensemble learning system as claimed in claim 2, wherein the weak classifier of each slave computing device is a decision tree model.

5. An ensemble learning system, comprising a plurality of slave computing devices, wherein each slave computing device is configured to:
share a weak classifier with other slave computing devices, and receive other weak classifiers from the other slave computing devices; and
use the weak classifier and the other weak classifiers to obtain a final classification result.

6. The ensemble learning system as claimed in claim 5, wherein each slave computing device is configured to:
during a training phase:
receive first sensor data from a sensor;
use the first sensor data to train the weak classifier; and
share the weak classifier with the other slave computing devices and receive the other weak classifiers from the other slave computing devices; and
during an inference phase:
receive second sensor data from the sensor; and
use the weak classifier and the other weak classifiers to classify the second sensor data and obtain the final classification result;
wherein the data format of the first sensor data for each slave computing device is the same.

7. The ensemble learning system as claimed in claim 6, wherein each slave computing device is further configured to perform the following operations during the inference phase:
input the second sensor data to the weak classifier and the other weak classifiers to obtain individual classification results; and
based on the classification results, to output the final classification result.

8. The ensemble learning system as claimed in claim 7, wherein each slave computing device is further configured to:
during the inference phase, take the mode of the classification results as the final classification result.

9. The ensemble learning system as claimed in claim 6, wherein the weak classifier of each slave computing device is a decision tree model.

10. An ensemble learning method, executed on a computer system, the computer system comprising a plurality of slave computing devices and a master computing device, and the ensemble learning method comprising:
using a weak classifier through each slave computing device to obtain a classification result; and
using the master computing device to receive the classification results from the slave computing devices, and based on the classification results, to output a final classification result.

11. The ensemble learning method as claimed in claim 10, further comprising:
during a training phase:
using each slave computing device to receive first sensor data from a sensor, and using the first sensor data to train the weak classifier; and
during an inference phase:
using each slave computing device to receive second sensor data from the sensor, and using the weak classifier to obtain the classification result for the second sensor data; and
using the master computing device to receive the classification results from the slave computing devices, and based on the classification results, to output the final classification result.

12. The ensemble learning method as claimed in claim 11, further comprising, during the training phase, performing the following operations through each slave computing device:
sharing a portion of the first sensor data with other slave computing devices, and receiving the shared portions from the other slave computing devices; and
using the first sensor data and the shared portions to train the weak classifier;
wherein the data format of the first sensor data for each slave computing device is the same.
